(19) United States
(12) Patent Application Publication
(10) Pub. No.: US 2016/0374516 A1
(43) Pub. Date: Dec. 29, 2016

(54) MULTIFUNCTIONAL APPARATUS FOR USE IN THE KITCHEN

(71) Applicant: Franke Technology and Trademark Ltd, Hergiswil (CH)

(72) Inventor: Michael Lammel, Aachen (DE)

(73) Assignee: Franke Technology and Trademark Ltd, Hergiswil (CH)

(21) Appl. No.: 15/190,725

(22) Filed: Jun. 23, 2016

(30) Foreign Application Priority Data
Jun. 23, 2015 (DE) 102015110096.7

(51) Int. Cl. A47J 47/00; G01G 23/36; F21V 8/00; F21V 23/04; F21V 31/00; G01G 19/52; F21V 33/00

(52) U.S. Cl. CPC A47J 47/005; G01G 19/52; G01G 23/36; F21V 33/0024; F21V 23/04; F21V 31/005; G02B 6/0011; F21V 23/0471; F21Y 2115/15; F21Y 2105/00

(57) ABSTRACT

A multifunctional apparatus for use in the kitchen is provided, having a lower housing; an upper cover plate of at least partially translucent design; at least one light source arranged within the housing; at least one weight sensor arranged between the housing and the cover plate or on a bottom face of the housing; at least one operator control element for selectively activating a lighting mode and/or a weighing mode. A kitchen work surface, including a kitchen sink having at least one sink basin which has a circumferential basin edge, and the multifunctional apparatus, as defined above, is also provided. The basin edge and the housing of the multifunctional apparatus are complementary at least in regions, so that the multifunctional apparatus can be suspended in the sink basin in the edge region, and a top face of the cover plate and a sink edge or a sink surface preferably lie in or define a common plane.

### INCORPORATION BY REFERENCE

The following documents are incorporated herein by reference as if fully set forth: German Patent Application No. 102015110096.7, filed Jun. 23, 2015.

### BACKGROUND

The invention relates to a multifunctional apparatus for use in the kitchen.

This invention also relates to a kitchen work surface, comprising a kitchen sink having at least one sink basin which has a circumferential basin edge, and comprising a multifunctional apparatus according to the invention.

Kitchens and the functional apparatuses used therein nowadays always also have to meet specific design requirements in addition to the requirements in respect of the function itself. It is particularly advantageous when various functions are also combined in one and the same object because, in this case, firstly a certain organizational effect can be achieved by a reduction in the number of objects required and secondly added design value can also be achieved.

Nowadays, a set of scales or the like is used in every kitchen in order to be able to portion foodstuffs correctly. In addition, every kitchen has a chopping board or the like in order to be able to cut up foodstuffs. Suitable work surface illumination plays an important role in the latter process in particular, this illumination often not being uniform at all in the kitchen or throughout the kitchen—for example when the cook bends over the chopping board while chopping.

### SUMMARY

The invention is based on the object of reducing the number of individual functional objects required in the kitchen and, in the process, of further achieving added esthetic value.

This object is achieved by a multifunctional apparatus having one or more features of the invention and a kitchen work surface also having one or more features of the invention. Advantageous developments of the invention are described below and in the claims.

According to the invention, a multifunctional apparatus for use in the kitchen comprises: a lower housing; an upper cover plate which is of at least partially translucent design; at least one light source which is arranged within the housing in the region of the cover plate; at least one weight sensor which is arranged between the housing and the cover plate or on a bottom face of the housing; and at least one operator control element for selectively activating a lighting mode with a switched-on light source and/or a weighing mode with a switched-on weight sensor.

In the present case, the term “weight sensor which is arranged on a bottom face of the housing” covers both weight sensors which are arranged entirely below and/or outside the housing of the multifunctional apparatus and also weight sensors of the kind which are inserted into apertures on the bottom face of the housing and are therefore located at least also partially within the housing.

The invention therefore firstly integrates a set of (domestic) scales and an illumination apparatus and in this way reduces the number of individual functional objects required in the kitchen, in order to further achieve added esthetic value in the process.

In this case, it can be provided in a development that various light intensities and/or light colors can be switched or selected in the lighting mode, preferably in accordance with one or more of the following modes: illumination mode, background light mode, ambient light mode, mood light mode. In this way, optimum lighting results can be achieved and the added esthetic value can be further increased. It is also possible to automatically change between at least some of said modes.

In order to always ensure an optimum illumination situation even during chopping processes, it can further be provided that the cover plate itself is in the form of a chopping board and is designed to be correspondingly cut-resistant. This also reduces the number of individual functional objects required in the kitchen once again.

For reasons of hygiene, strength and esthetics, the cover plate can be formed using a glass or glass-ceramic material which is preferably printed and/or coated on the rear face, at least in regions in order to achieve targeted optical-visual effects, for example by fitting a manufacturer logo or the like. In addition, specific active regions (operator control regions) of the multifunctional apparatus can be correspondingly labeled, for example the at least one operator control element.

Furthermore, it can be provided that the multifunctional apparatus, given a corresponding design and development, has a locking means for the cover plate with respect to the housing in order to protect the at least one weight sensor when the multifunctional apparatus is being used as a chopping board.

In a development, the multifunctional apparatus can also comprise a rechargeable energy source, in particular in the form of a rechargeable battery, which can preferably be charged by means of a micro-USB connection and is extremely preferably arranged centrally with respect to the multifunctional apparatus, in particular for reasons of mass balance. The energy source supplies electrical energy to all of the electrical loads of the multifunctional apparatus, in particular the weight sensor and the light source. Therefore, the multifunctional apparatus can be used substantially autonomously locally.

In view of its intended use in the kitchen, the multifunctional apparatus is preferably designed to be water-tight overall, in particular to be protected against splashes, and to be insensitive to the action of soiling from the outside.

The housing of the multifunctional apparatus can have a circumferential edge profile which is designed to at least partially complement a basin edge profile of a preferably commercially available kitchen sink and extremely preferably has a circumferential, concave shoulder which is, in particular, of rounded design. In this way, the multifunctional apparatus can be reliably placed in the region of the basin edge of the sink, without slipping during weighing or chopping.

Depending on requirements, the housing of the multifunctional apparatus can be formed using metal or plastic.

The housing of the multifunctional apparatus is preferably designed in the form of a tub and is open in the direction of the cover plate or is substantially closed off to the outside by means of the cover plate. This housing accommodates all of the functional elements of the multifunctional apparatus in a protective manner.

Given a corresponding design of the multifunctional apparatus, the cover plate of the multifunctional apparatus can be mounted such that it can move relative to the housing perpendicular to the plane of the plate, preferably by means of the at least one weight sensor, in order to ensure the weighing function. Accordingly, the housing and the cover plate can be mechanically coupled by means of the at least one weight sensor.

However, as an alternative, it can also be provided that, given a corresponding design of the multifunctional apparatus, the cover plate is connected to the housing in a substantially fixed manner. In this case, the at least one weight sensor can, as already mentioned, be provided on the bottom face of the housing. This constitutes a robust variant of the multifunctional apparatus which can be realized in a particularly cost-effective manner.

The multifunctional apparatus preferably comprises a plurality of weight sensors, for example one at each corner, that is to say four in the case of a preferably rectangular design, specifically both in the case of the variant with a cover plate which moves with respect to the housing and also in the case of the variant with a cover plate which is stationary with respect to the housing.

In a development of the multifunctional apparatus, at least one of the following components can be arranged at least partially in the housing beneath the cover plate: the weight sensor, preferably a piezoelectric sensor, extremely preferably a plurality of sensors of this kind, provided that said sensor/sensors is/are not arranged entirely beneath (outside) the housing; the light source; at least one on/off switch (operator control element), preferably in each case at least one for the lighting mode and for the weighing mode, preferably in the form of a capacitive switch; the energy source; at least one plug connection, preferably for charging the energy source, preferably in the form of a micro-USB connection; at least one switching element, preferably for switching over or selecting a weighing unit and a display device for displaying a weighing result.

In order to ensure protection against moisture and soiling, it can be provided in a development of the multifunctional apparatus that a preferably continuously circumferential seal is provided between the housing and the cover plate. This seal or diaphragm can be of flexible design in order to absorb any relative movements between the cover plate and the housing.

The display device and/or the light source can be fixed to the bottom of the cover plate or can be arranged tightly adjacent to this cover plate in order to ensure good visibility (readability) through the cover plate from the outside. Therefore, the cover plate is of translucent or even clearly transparent design at least where the display device and/or the light source are/is arranged.

In a development of the multifunctional apparatus, the light source can have a light guide device in addition to the actual light generator, for example a single light-emitting diode, in order to achieve a lighting effect over a surface area, or the light source can comprise at least one flat light generator, such as an OLED element or the like. A plurality of flat light generators of this kind are preferably interconnected in order to achieve the intended lighting effect over a surface area.

The display device can be invisible from outside the cover plate when the weighing mode is not active and can be visible from outside the cover plate only when the weighing mode is active, wherein the display device is preferably—for example but without any restriction—in the form of a 7-segment display.

The plug connection can—for example and without any restriction—be in the form of a standard or micro-USB connection which is preferably arranged on a relatively long housing side of the apparatus, and which is extremely preferably protected against soiling and/or splashing by means of a cover (stopper) when the multifunctional apparatus is in use.

A further aspect of the invention relates to a kitchen work surface, comprising a kitchen sink having at least one sink basin which has a circumferential basin edge, and comprising a multifunctional apparatus, as described above, wherein the basin edge and the housing of the multifunctional apparatus are designed to be complementary at least in regions and have dimensions which are matched to one another, so that the multifunctional apparatus can be suspended in the sink basin, wherein a top face of the cover plate and a sink surface preferably lie in a common plane or define a common plane. The sink which is provided with this equipment then has—depending on the design of the multifunctional apparatus—a weighing, chopping and illumination function. In this case, the weighing function can be used in particular and preferably when the multifunctional apparatus according to the variant is designed with a cover plate and a housing which can move relative to one another.

### BRIEF DESCRIPTION OF THE DRAWINGS

Further properties and advantages can be gathered from the following description of exemplary embodiments with reference to the drawings.

FIG. 1 shows a perspective overall view of a multifunctional apparatus according to the invention;

FIG. 2 shows the multifunctional apparatus from FIG. 1 when used as intended on a kitchen sink;

FIG. 3 shows a plan view of the multifunctional apparatus from FIG. 1;

FIG. 4 shows a view of the rear face of the multifunctional apparatus from FIG. 1;

FIG. 5 shows an internal design of a multifunctional apparatus analogously to FIG. 1;

FIG. 6 shows the housing and the cover plate in an alternative multifunctional apparatus;

FIG. 7 shows a longitudinal section through the multifunctional apparatus according to FIG. 6;

FIG. 8 shows a side view of the multifunctional apparatus according to FIG. 6;

FIG. 9 shows a first refinement of the light source in a multifunctional apparatus analogously to FIG. 1; and

FIG. 10 shows a second refinement of the light source in a multifunctional apparatus analogously to FIG. 1.

### DETAILED DESCRIPTION OF THE PREFERRED EMBODIMENTS

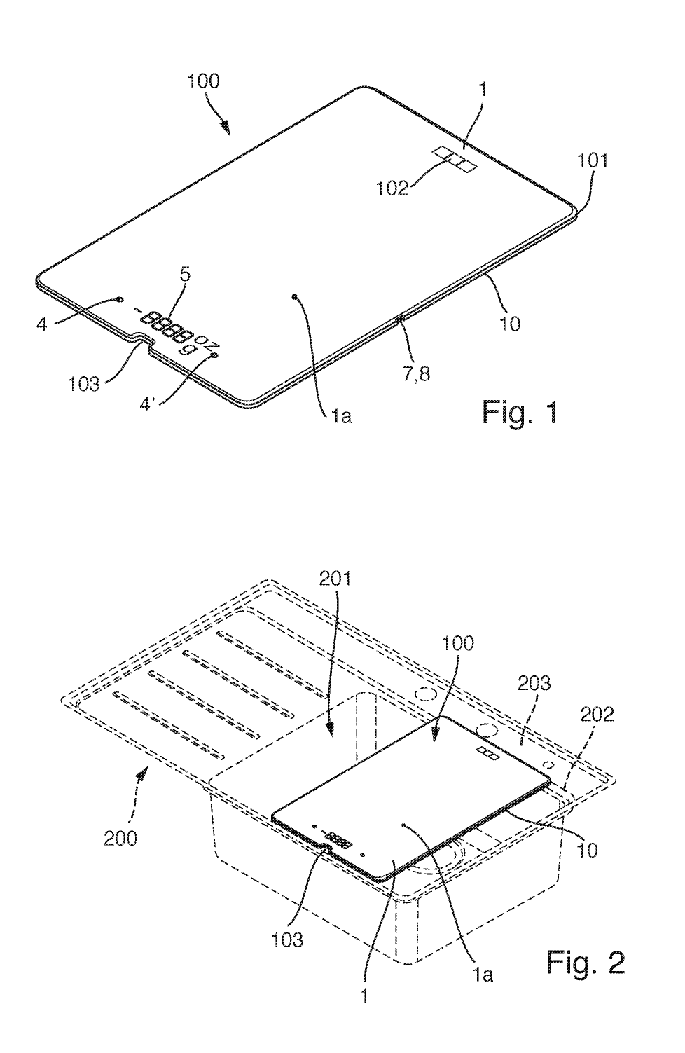

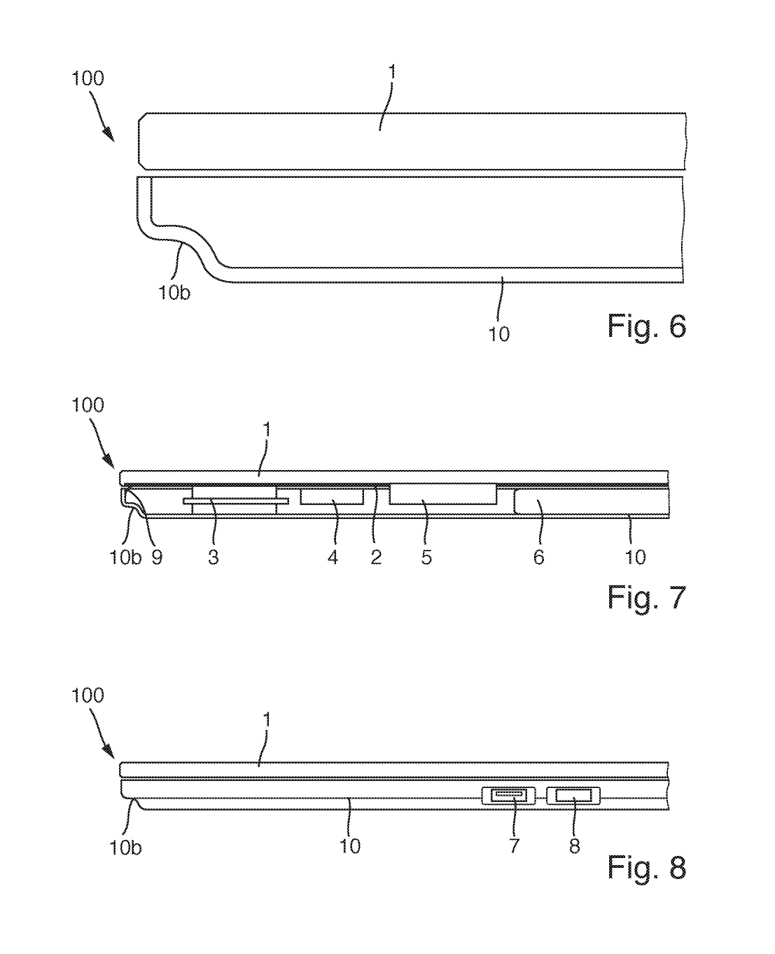

FIG. 1 shows a perspective overall view of a multifunctional apparatus 100 according to the invention. The multifunctional apparatus 100 is designed in the form of a flat, planar board and has rectangular dimensions and rounded corners 101. The multifunctional apparatus (or, for short: “apparatus”) 100 comprises a lower, tub-like housing 10, preferably comprised of a metal or plastic, and an upper cover plate 1 which is translucent overall and which can be formed from a cut-resistant glass material. A (company) logo is provided at reference symbol 102, it being possible for this logo to be engraved into the cover plate 1 or to be printed onto the top face or bottom face of this cover plate. A recess in a short side of the apparatus 100 is illustrated at reference symbol 103 in order to be able to easily handle this apparatus when it is used as intended in accordance with FIG. 2. Reference symbols 4, 4′ each denote an operator control element, specifically for activating/deactivating a lighting mode or weighing mode, this being discussed in greater detail further below. The respective location of the operator control elements 4, 4′ can be identified by a corresponding printing or an engraving on the cover plate 1, as depicted. A display or an associated display device is illustrated at reference symbol 5, wherein this display or associated display device is arranged beneath the translucent cover plate 1, so that the actual display—in the active state—is visible through the cover plate 1. In the present case, the display is designed—for example and without any restriction—as a seven-segment display. At reference symbols 7, 8, the apparatus 100 has a plug connection or a switching element, this being discussed more precisely further below. Plug connection 7 and switching element 8 do not have to be arranged in a common position with respect to the rest of the apparatus 100. The housing 10 can—as illustrated here—have an excess length and an excess width in relation to the cover plate 1, without the invention being restricted to this (cf. FIG. 6 et seq.). A flush termination is also possible, or the cover plate 1 can even project beyond the housing 10.

An intended use of the apparatus 100 is clearly illustrated in FIG. 2: a substantially conventional kitchen sink 200 has a sink basin 201 with a circumferential basin edge 202 which is adjoined by a substantially planar sink surface 203. The dimensions of the relatively long sides of the apparatus are such that this apparatus just bridges the sink basin 201—as illustrated—and in the process rests on the basin edge 202 by way of the edge of the housing 10 in the region of the relatively short sides. In this case, a surface 1a of the cover plate 1 and the sink surface 203 preferably define a common plane. The apparatus 100 can be easily put into the illustrated position and, respectively, removed from said position by the recess 103. The surface 1a of the cover plate 1 or the entire cover plate 1 is preferably of cut-resistant design, so that the apparatus—in particular in the shown position—can be used as a chopping board.

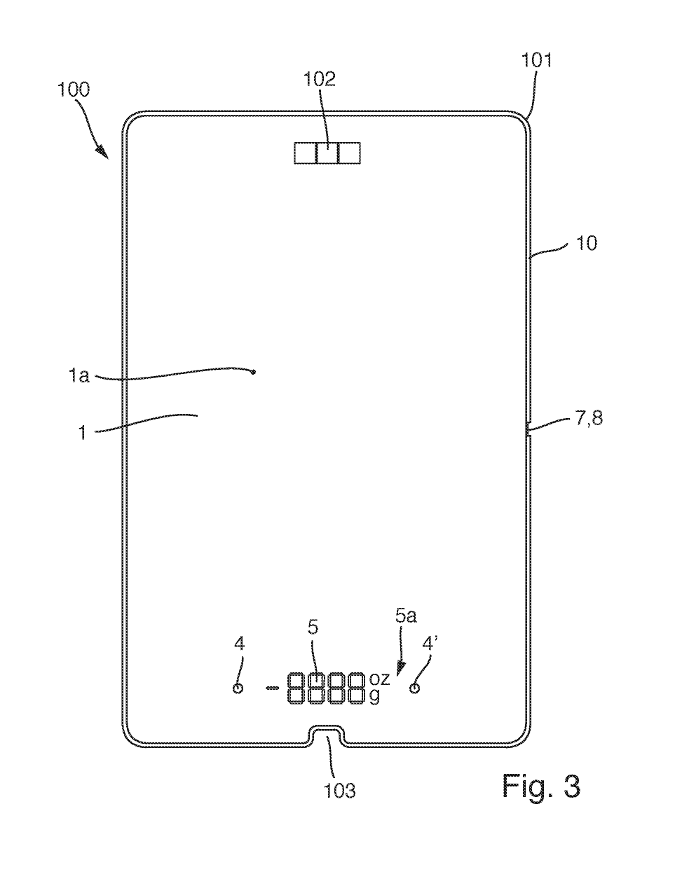

FIG. 3 illustrates a plan view of the apparatus 100. Reference has already been made to the essential elements of the apparatus 100. The recess 103 for removing the apparatus 100 from a sink basin in a simple manner is easily identifiable (cf. FIG. 2). The operator control element 4 is in the form of a capacitive proximity switch or the like which reacts to a human finger approaching. This operator control element serves to switch on/switch off a lighting mode in which the apparatus 100 operates as an illumination apparatus, or to select a specific light intensity or light color, for which purpose the apparatus has at least one light source, this being discussed in more detail further below, for example by tapping this operator control element several times in succession. The further operator control element 4′ is also in the form of a capacitive proximity switch or the like which reacts to a human finger approaching. This further operator control element serves, for example by being tapped several times in succession, to switch on/off a weighing mode, in which the apparatus 100 operates as a set of scales, and, respectively, to set a tare function in order to set the display 5 to zero before the actual weighing process. In addition to the display 5 for the weighing result, a further display for a selected weighing unit (grams (g) or ounces (oz.)) can be found at reference symbol 5a. The weighing unit can be selected by means of the abovementioned switching element 8 which can be specially designed as a pushbutton. The lighting mode and the weighing mode can be activated and deactivated independently of one another. Automatic switch-off preferably takes place after a certain time.

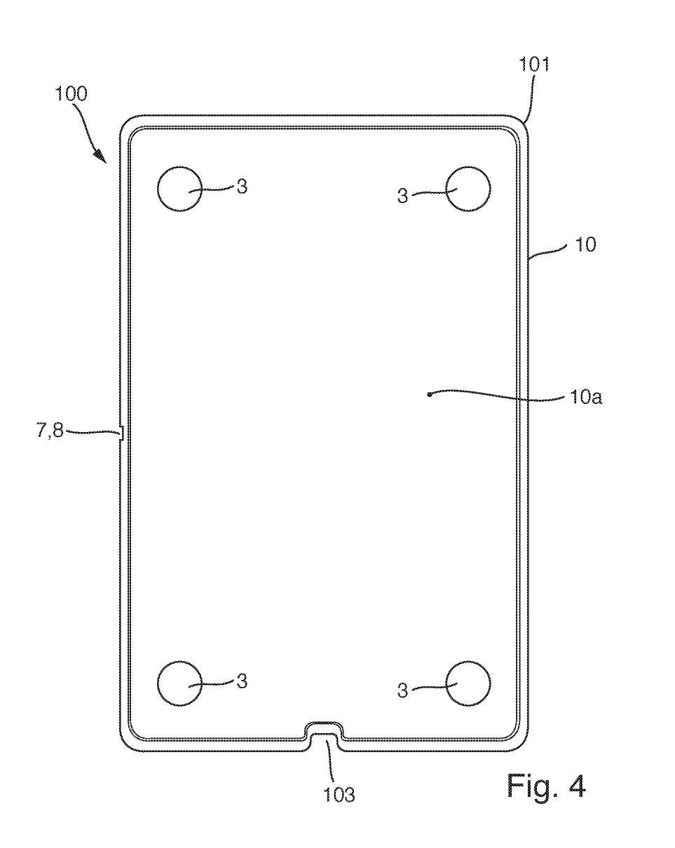

FIG. 4 shows a rear view of the apparatus 100. The housing 10 accordingly has a—for example and without any restriction—piezoelectric weight sensor 3 on its rear face 10a in the region of each of its four corners. This weight sensor at the same time serving as a supporting foot and preferably being provided with a relatively soft, anti-slip material at least on the base, so that the apparatus 100, unlike the manner illustrated in FIG. 2, can also be reliably used on a flat surface area, for example of a kitchen worktop.

The interior design of the apparatus 100 will now be described more precisely with reference to the following figures.

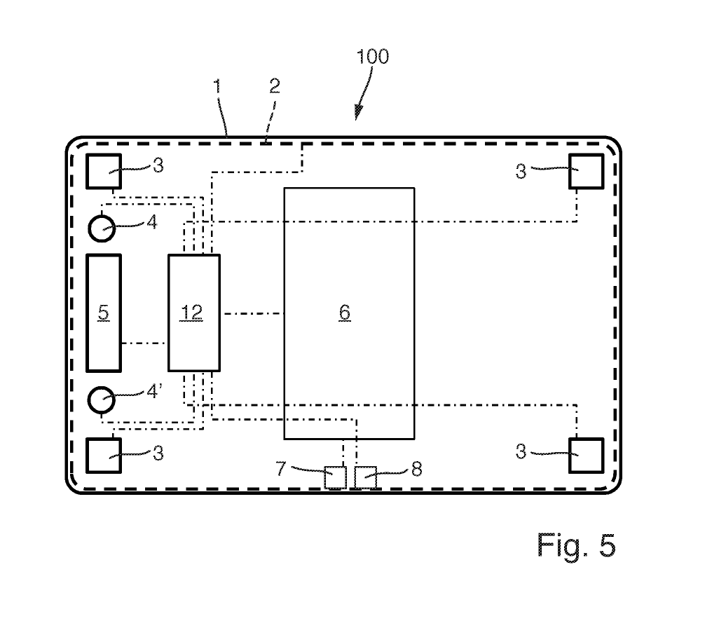

FIG. 5 illustrates an imaginary view, through the cover plate 1, of the further elements which are located beneath this cover plate in one refinement of the apparatus 100, which elements normally cannot be identified as such—for example since the cover plate 1 is not of clearly transparent design, but rather is opaque like frosted glass. The housing of the apparatus 100 is not shown in this figure. Reference sign 2 denotes a flat light source which is activated (on/off) or switched over (light intensity, type of illumination, color, . . . ) by the operator control element 4 in the lighting mode. Possible structural refinements of the light source 2 will be discussed further below. Reference symbol 3 respectively denotes a weight sensor which can be in the form of a piezoelectric sensor. In each case one—for example and without any restriction—piezoelectric weight sensor 3 is arranged in each corner of the apparatus 100. With respect to the variant shown in FIG. 4, each of the weight sensors 3 projects out of the housing (not shown here) at the bottom. An alternative refinement will be explained in greater detail further below with reference to FIG. 7. The cover plate 1 (in the alternative refinement) can, by means of the weight sensors 3, be mechanically coupled to the housing (not shown here) and mounted such that it can move relative to this housing in a direction perpendicular to the plane of the cover plate 1. With respect to the variant shown in FIG. 4, the cover plate 1 and the housing are connected in a fixed manner. The light source 2, the weight sensors 3, the operator control elements 4, 4′, the display device 5 and also the switching element 8 are operatively connected to a central control and evaluation unit 12 so as to transmit signals, this being symbolized by corresponding dash-and-dot lines. The control and evaluation unit 12 evaluates the respectively received signals and drives the corresponding elements in a suitable manner—for example the display device 5 for displaying a weighing result according to the weight sensors 3 in the weight unit (g/oz.) selected using the switching element 8, or the light source 2 for activating a selected lighting mode (for example muted background light). Reference symbol 6 denotes a centrally arranged rechargeable battery which serves as an energy source for all of the electrical loads of the apparatus 100, in particular the light source 2, the weight sensors 3 and the control unit 12, this not being explicitly depicted. The rechargeable battery is recharged as required by the plug connection 7, but preferably, for example and without restriction, a micro-USB connection.

FIG. 6 shows a first sectional view through a refinement of the apparatus 100 in the edge region of the cover plate 1 and the housing 10, wherein, in the shown refinement, the cover plate 1 and the housing 10—unlike in FIGS. 1-4—terminate substantially flush. In the lower edge region at reference symbol 10b, the housing 10 has a preferably circumferential, concave recess or a preferably circumferential, concave shoulder which is of rounded design in particular and which specially serves to arrange the apparatus 100, as shown in FIG. 2 by way of example, on a sink. The size and shape of the recess 10b are preferably matched to a correspondingly complementary structure of the sink (for example a basin edge or a basin edge profile).

FIG. 7 illustrates a further sectional view through a refinement of the apparatus 100, for example looking from the left according to FIG. 5, wherein the rechargeable battery 6 is however shown in a manner displaced laterally in relation to FIG. 5 for reasons of clarity. The manner in which the illustrated weight sensor 3 realizes a connection between the housing 10 and the cover plate 1, which are mounted such that they can move in relation to one another, in this variant of the apparatus 100 is easily identifiable. Therefore, a weighing function can also be implemented in the position shown in FIG. 2. The operator control element 4 is arranged close to the cover plate 1 in order to be able to be influenced in a capacitive manner when, for example, a finger approaches. It goes without saying that this also applies to the further operator control element 4′ not shown here. The display device 5 and the light source 2 are situated immediately beneath the cover plate 1, so that the lighting effect and the display effect come into play in an optimum manner. A circumferential seal 9 (sealing diaphragm) is located between an upper edge of the housing 10 and the bottom face of the cover plate 1 in order to protect the elements within the housing 10 against the action of water and/or dirt from the outside. As already mentioned, the weight sensor 3 can, as an alternative, also protrude out of the housing 10 at the bottom or even be arranged entirely outside or beneath the housing 10. The housing 10 and the cover plate 1 can then be connected in a fixed manner, this producing a particularly cost-effective and robust design. In this case, the provision of the seal 9 (sealing diaphragm) can be dispensed with under certain circumstances.

FIG. 8 shows a side view of a refinement of the apparatus 100 in the region of one of the relatively long sides. The plug connection 7 (here—for example and without any restriction—a standard USB connection or the like) and the switching element (pushbutton) 8 can be easily identified in this figure. In order to close, in particular, the plug connection 7 when the apparatus 100 is used as intended, a correspondingly shaped closure element (stopper) can be provided (not shown).

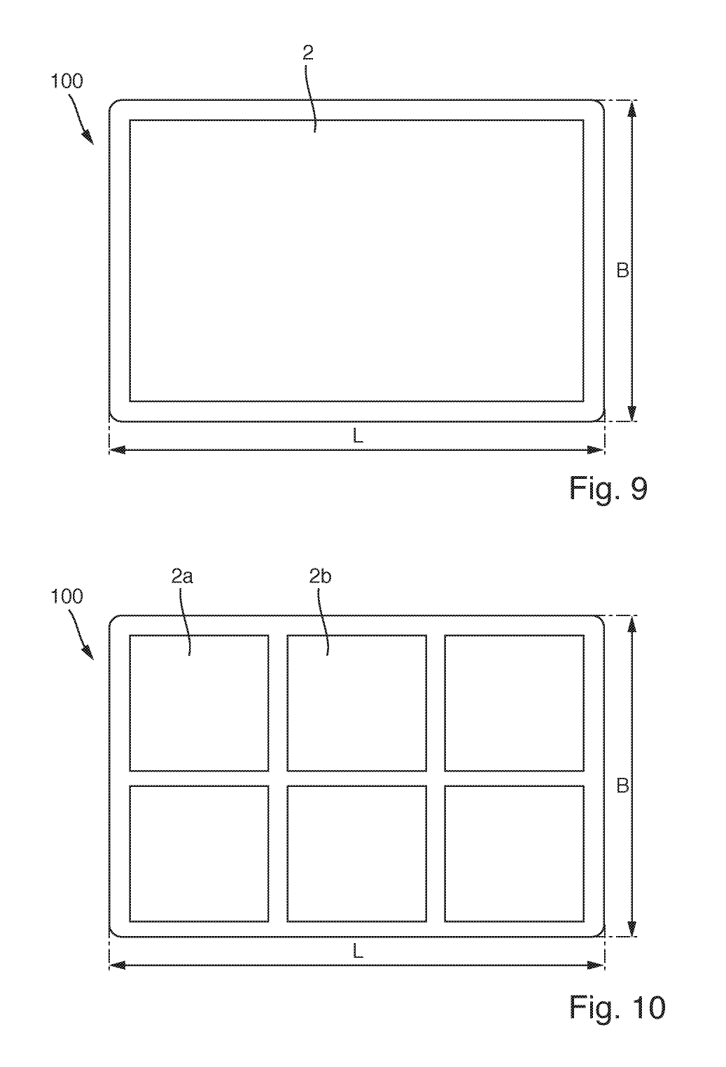

FIG. 9 shows, in one refinement of the apparatus 100, a possible way of realizing the light source 2 as a flat light guide device which can interact with, in principle, a single light generator, for example a light-emitting diode (not shown) so as to transmit light, in order to achieve a lighting effect over a surface area, as is known from eBook reading devices for example. A plurality of light generators can also be used in order to generate, for example, different colors. FIG. 9 denotes, by way of example, the short side of the apparatus 100 using reference symbol B and the long side using reference symbol L, it being possible for this to apply, in principle, to all of the embodiments shown.

FIG. 10 shows, in another refinement of the apparatus 100, a further possible way of realizing the light source 2 as a grid arrangement comprising a plurality of flat light generators 2a, 2b, . . . which can be designed, for example, as OLED elements and can be arranged in the illustrated manner in order to likewise achieve a lighting effect over a surface area. A plurality of different light generators 2a, 2b, . . . can also be used in order to generate, for example, different colors. FIG. 10 denotes, once again by way of example, the short side of the apparatus 100 using reference symbol B and the long side using reference symbol L, it being possible for this to apply, in principle, to all of the embodiments shown.

When used on a kitchen sink as intended, the apparatus 100 creates a novel kitchen work surface which combines practical (chopping and weighing) and esthetic functions (illumination) in an elegant and attractive manner.

1. A multifunctional apparatus (100) for use in the kitchen, comprising:
a lower housing (10);
an upper cover plate (1) which is at least partially translucent;
at least one light source (2; 2a, 2b) arranged within the housing (10) in a region of the cover plate (1);
at least one weight sensor (3) arranged between the housing (10) and the cover plate (1) or on a bottom face (10a) of the housing (10);
at least one operator control element (4, 4′) configured to selectively activate at least one of a lighting mode with a switched-on light source (2) or a weighing mode with a switched-on weight sensor (3).

2. The multifunctional apparatus (100) according to claim 1, wherein various light intensities, light colors, or light intensities and light colors are switchable in the lighting mode, in accordance with at least one of the following modes: an illumination mode, a background light mode, an ambient light mode, or a mood light mode.

3. The multifunctional apparatus (100) according to claim 1, wherein the cover plate (1) comprises a chopping board.

4. The multifunctional apparatus (100) according to claim 1, wherein the cover plate (1) is formed using a glass or glass-ceramic material which is at least one of printed or coated on a rear face, at least in regions (102).

5. The multifunctional apparatus (100) according to claim 1, further comprising a rechargeable energy source (6) that is chargeable by a connection (7).

6. The multifunctional apparatus (100) according to claim 1, wherein the multifunctional apparatus (100) is water-tight.

7. The multifunctional apparatus (100) according to claim 1, wherein the housing has a circumferential edge profile (10b) which is at least partially complementary to a basin edge profile of a kitchen sink (200).

8. The multifunctional apparatus (100) according to claim 1, wherein the housing (1) is formed using metal or plastic.

9. The multifunctional apparatus (100) according to claim 1, wherein the housing (1) is comprises a tub and is open in a direction of the cover plate (1) and is substantially closed off to outside by the cover plate (1).

10. The multifunctional apparatus (100) according to claim 1, wherein the cover plate (1) is mounted to move relative to the housing (10) perpendicular to a plane of the plate, or the cover plate (1) is connected to the housing (10) in a substantially fixed manner.

11. The multifunctional apparatus (100) according to claim 1, wherein at least one of the following components is arranged at least partially in the housing (10) beneath the cover plate (1):
the weight sensor (3);
the light source (2; 2a, 2b);
at least one on/off switch (4);
an energy source (6);
at least one plug connection (7) for charging the energy source (6);
at least one switching element (8) to switch over or select a weighing unit;
a display device (5, 5a) that displays a weighing result.

12. The multifunctional apparatus (100) according to claim 1, wherein the housing (10) and the cover plate (1) are mechanically coupled via at least one weight sensor (3).

13. The multifunctional apparatus (100) according to claim 1, wherein a continuously extending circumferential seal (9) is provided between the housing (10) and the cover plate (1).

14. The multifunctional apparatus (100) according to claim 1, further comprising a display device (5), wherein at least one of the display device or the light source (2; 2a, 2b) are fixed to a bottom of the cover plate (1) or ares arranged tightly adjacent to said cover plate.

15. The multifunctional apparatus (100) according to claim 1, wherein the light source (2) interacts with a light guide device in order to achieve a lighting effect over a surface area, or the light source (2a, 2b) comprises at least one OLED element.

16. The multifunctional apparatus (100) according to claim 1, further comprising a display device, where in the display device (5) is substantially invisible from outside the cover plate (1) when the weighing mode is not active and is visible from outside the cover plate (1) only when the weighing mode is active, and the display device (5) is a 7-segment display.

17. The multifunctional apparatus (100) according to claim 1, further comprising a plug connection, wherein the plug connection (7) is a standard or micro-USB connection and is arranged on the housing.

18. A kitchen work surface, comprising a kitchen sink (200) having at least one sink basin (201) which has a circumferential basin edge (202), and a multifunctional apparatus (100) according to claim 1, wherein the basin edge (202) and the housing (10) of the multifunctional apparatus (100) are complementary to one another at least in regions and have dimensions which are matched to one another, so that the multifunctional apparatus (100) is suspended in the sink basin (201) in an edge region, and a top face (1a) of the cover plate and a sink edge or a sink surface (203) lie in or define a common plane.
